(19) United States
(12) Patent Application Publication
(10) Pub. No.: US 2005/0274000 A1
(43) Pub. Date: Dec. 15, 2005

(54) Methods for fabricating lithium rechargeable batteries

(75) Inventors: Bookeun Oh, Waltham, MA (US); Khalil Amine, Downers Grove, IL (US)

Correspondence Address: FOLEY & LARDNER, 150 EAST GILMAN STREET, P.O. BOX 1497, MADISON, WI, 53701-1497, US

(73) Assignee: The University of Chicago

(21) Appl. No.: 11/135,101

(22) Filed: May 23, 2005

Related U.S. Application Data
(60) Provisional application No. 60/579,435, filed on Jun. 14, 2004.

(51) Int. Cl. H01M 10/04

(52) U.S. Cl. 29/623.3; 429/300

(57) ABSTRACT

There are provided novel methods of fabricating batteries, particularly rechargeable lithium ion batteries comprising a microporous polymeric gel layer on one or more electrodes of the batteries. The methods include laminating a gellable polymer film to at least one electrode and forming a microporous gellable polymer layer from the laminated film on the electrode. The microporous gellable polymer layer can be produced by extracting plasticizer from the polymer with a solvent. The polymeric gel on the electrode can be formed by exposing the microporous gellable polymer layer to an electrolyte solution which includes a lithium salt.

### GOVERNMENT RIGHTS

The United States Government has rights in this invention pursuant to Contract No. W-31-109-ENG-38 between the United States Department of Energy and the University of Chicago representing Argonne National Laboratory.

### FIELD OF THE INVENTION

The present invention relates generally to lithium rechargeable batteries and methods of fabrication thereof. More particularly the invention relates to methods of fabricating lithium rechargeable batteries comprising electrodes with a microporous gellable polymer layer.

### BACKGROUND OF THE INVENTION

Lithium ion batteries constitute the fastest growing segment of the rechargeable battery market. They are lightweight, have a high energy density, and do not suffer from memory effects. Due to these advantages, lithium ion rechargeable batteries are now widely used in consumer products as an energy source. However, they suffer from certain safety problems due to the use of volatile solvents in the Li ion electrolytes. For example, lithium ion batteries can explode upon exposure to high temperatures. The potential leakage of corrosive electrolyte solutions pose another danger. Hence, such batteries have been largely confined to small-sized electronic device applications such as mobile phones.

To alleviate such safety problems, the use of gel polymer electrolytes has been proposed for lithium rechargeable batteries. The advantages of gel polymer electrolytes compared to liquid electrolytes include improved safety and low swelling at temperatures above 80° C. in a plastic/metal package form. For example, the vapor pressure of organic solvents is generally lower in gel polymer electrolytes. In addition, gel polymer electrolytes provide good adhesion and prevent electrolyte leakage by confining solvents within the polymer. Unfortunately, gel polymer electrolytes suffer from higher impedances than liquid electrolytes, and are generally unsuitable for high power applications such as in hybrid electric vehicles (HEV).

To improve the performance of the batteries with gel polymer electrolytes, several modified fabrication methods have been proposed, especially focused on the formation of new gel polymer separators for the methods. In Japanese Patent 03-177410, a new porous separator was developed by impregnating a mixture of a crosslinkable chemical and liquid electrolyte into a porous separator and stabilizing the separator through thermal curing. U.S. Pat. No. 6,475,678 issued Nov. 5, 2002 to Suzuki teaches a lithium rechargeable cell made up of electrodes with polymer latex layers. An electrolyte solution was injected after cell fabrication. The injected electrolyte swells the polymer latex and forms a physical gel.

U.S. Pat. No. 6,676,713 issued Jan. 13, 2004 to Okada et al., discloses another polymer coating method. Electrodes are soaked in a polymer solution and undergo a phase-inversion treatment to make a porous structure to the coated polymer layer. Among these methods, the formation of a gellable porous polymer layer on electrodes is very helpful to reduce the internal resistance resulted in the high impedance. However, a drawback is the use of solvents to form the polymer layer. The solvents can swell the binder inside electrodes, changing the electrode structure and badly affecting the battery performance. A new method of battery fabrication which lacks these disadvantages is desirable.

### SUMMARY OF THE INVENTION

In accordance with the present invention there are provided novel methods of fabrication of batteries, particularly rechargeable lithium ion batteries, comprising a microporous polymeric gel layer on one or more electrodes of the batteries. The methods include laminating a gellable polymer film to at least one electrode and forming a microporous gellable polymer layer from the laminated film on the electrode. The lamination is performed without solvent. The microporous gellable polymer layer can be produced by extracting plasticizer from the polymer with a solvent. The polymeric gel on the electrode can be formed by exposing the microporous gellable polymer layer to an electrolyte solution which includes a lithium salt. The gellation process is typically carried out under low heat. Upon absorption of the electrolyte, the gel comprises a swollen and physically gelled microporous polymeric layer through which lithium ions move between electrodes during the charge/discharge cycles of the rechargeable battery.

Methods of the invention provide several advantages. Laminating the gellable polymer layer onto the electrodes according to inventive methods avoids the use of organic solvents that can deleteriously alter electrode structure. The gel polymer electrolyte is also safer than liquid lithium based electrolytes as outlined above. Moreover, the gellable microporous polymer layer formed on the surface of the electrodes surprisingly and unexpectedly enhances cycling performance of spinel type cathodes at temperatures above 50° C. by blocking or delaying the Mn(II) migration to the surface of graphite anode that would otherwise cause capacity decays.

### BRIEF DESCRIPTION OF THE DRAWINGS

FIG. 1 is a schematic diagram of the fabrication method of an electrode with a gellable polymer film to form a gellable microporous polymer layer on the surface of the electrode by use of thermal lamination.

FIG. 2 is a cross-sectional view of graphite anode (B) which is a mesophase carbon micro-bead (MCMB) anode with poly(vinylidene fluoride-co-hexafluoropropylene) microporous layer (A).

FIG. 3 is a graph of ASI values as a function of depth of discharge (DOD) (5 CmA based HPPC test at 25° C.) of lithium rechargeable cells fabricated in accordance with the invention.

FIG. 4 is a graph of ASI values as a function of storage time (3 CmA pulse per day test at 55° C.) of lithium rechargeable cells fabricated in accordance with the invention.

FIG. 5 is a graph of ASI values as a function of depth of discharge (DOD) (5 CmA based HPPC test at 25° C.) and a period of aging at 55° C. of lithium rechargeable cells fabricated in accordance with the invention.

FIG. 6 is a graph of ASI values as a function of DOD (5 CmA based HPPC test at 25° C.) of lithium rechargeable cells fabricated in accordance with the invention.

FIG. 7 is a graph of C₁/2 mA cycle life data (1-50 cycles at 25° C. and 51-100 cycles at 55° C.) of lithium rechargeable cells fabricated in accordance with the invention.

FIG. 8 is a graph of C₁/2 mA cycle life data at 55° C. of a lithium rechargeable cell fabricated in accordance with the invention.

FIG. 9 is a graph of C₁/2 mA cycle life data at 55° C. of a lithium rechargeable cell fabricated in accordance with the invention.

FIG. 10 is a graph of C₁/2 mA cycle life data (1-50 cycles at 25° C. and 51-69 cycles at 55° C.) of a lithium rechargeable cell fabricated in accordance with the invention.

FIG. 11 is a graph of C₁/2 mA cycle life data (1-50 cycles at 25° C. and 51-69 cycles at 55° C.) of lithium rechargeable cells fabricated in accordance with the invention.

FIG. 12 is a graph of ASI values as a function of DOD (5 CmA based HPPC test at 25° C.) of lithium rechargeable cells fabricated in accordance with the invention.

### DETAILED DESCRIPTION OF THE INVENTION

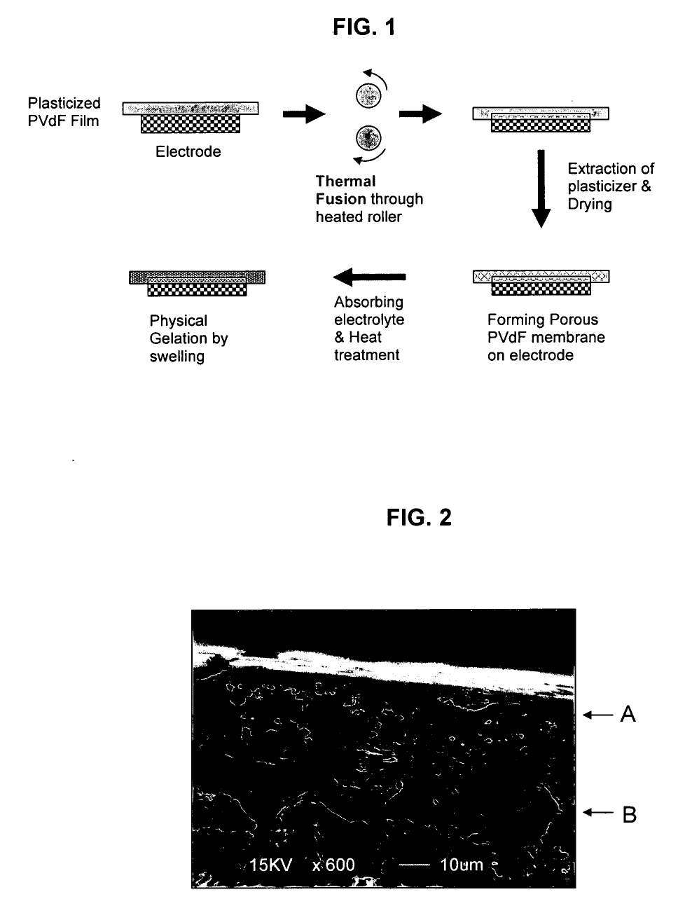

In accordance with one aspect, the present invention provides a method for fabricating a rechargeable lithium battery having a microporous gellable polymer layer on at least one electrode. The method includes laminating a gellable polymer film to at least one electrode without the use of an organic solvent during the lamination step. A microporous gellable polymer layer is formed from the laminated film on the electrode. The gellable polymer layer is a polymer film that will swell in the presence of solvent and electrolyte and form a gel. FIG. 1 outlines the fabrication process. Typically, the gellable polymer film is thermally laminated to the electrode at a temperature of, for example, from about 50° C. to about 130° C. The gellable polymer film can be directly laminated onto the electrodes by passing the film and electrodes through heated rollers. The gellable polymer film melts slightly and penetrates the surface of the electrodes to form a bonded structure between them. The gellable polymer layer can also be laminated through a hot press method. As in the heated roller method, the gellable polymer film is placed on the top of the electrode and interposed between two pre-heated metal plates at a temperature of, for example, from about 50° C. to about 130° C.

The gellable polymer film may be prepared from a polymer solution that includes a gellable polymer, inorganic filler and a plasticizer. Many polymers can be used to produce the gellable polymer used in the invention including, but not limited to, poly(vinylidene fluoride), poly(vinylidene chloride), polyacrylonitrile, polyacrylate, polyethylene oxide, polyurethane, copolymers thereof, or mixtures of any two or more thereof. To form the film, the polymer solution may be cast onto a plate and dried or it may be cast onto a porous nonwoven medium, e.g., a sheet, such as is well known to those of skill in the art.

Any suitable inorganic filler may be used in gellable polymer films of the invention including, any water absorbent, inorganic acid complexing agent, acid scavenger, hydrogen (H₂) neutralizer, or transition metal complexing agent that complexes Mn, Ni, Co, or Fe ions or the like. Exemplary inorganic fillers include, but not limited to, fumed silica, alumina, clay, molecular sieve, metallic stearates, hydrotalcite, hydrocalumite, zinc oxide, zirconium oxide, tungsten oxide, titanium oxide, or mixtures of any two or more thereof. The role of the inorganic fillers is to neutralize acids which are generated during cell operation and to form complexes with any transition metal ions which are dissolved in electrolytes from lithium metal oxide electrodes to ensure long-lasting cycle life of lithium rechargeable batteries. The latter function is particularly useful with spinel type electrodes. Another role of the inorganic fillers is to neutralize hydrogen generated from the anode which can cause safety issues with the cell.

The microporous structure is formed by extracting the plasticizer from the laminated film with the solvent. The extraction process may be performed according to known methods (see, e.g., U.S. Pat. No. 5,456,000 to Gozdz et al). Typically, the electrode with the laminated polymer film is dipped into the solvent one or more times to extract the plasticizer. The solvent is then removed by drying or other means. Exemplary solvents for extraction of the plasticizer include carbonates, ethers, alcohols, esters, silanes, phosphates, or mixtures of any two or more thereof. Plasticizers that may be used in the practice of the invention include alkylphthalates such as dibutyl phthalate or dioctyl phthalate or polyethylene glycols or mixtures of any two or more thereof. The pore sizes of the microporous polymer films formed by use of the present invention are typically submicron, but are not limited to any particular sizes. The pore sizes may vary from several hundred nanometers to several microns. After absorbing liquid electrolytes, the pores shrink or disappear due to swelling of the polymer film.

According to the present methods, the gellable polymer layer can be formed on the surface of the either the cathode, anode or both electrodes. The cathode for rechargeable cells of the present invention can include any lithiated or non-lithiated transition metal oxides such as, but not limited to, LiCoO₂, LiNiO₂, LiNi₁₋ₓCo_{y}Met_{z}O₂, LiMn_{0.5}Ni_{0.5}O₂, LiMn_{0.3}Co_{0.3}Ni_{0.3}O₂, LiFePO₄, LiMn₂O₄, LiFeO₂, vanadium oxide, and mixtures of any two or more thereof, wherein Met is Al, Mg, Ti, B, Ga, or Si; and 0≦x≦0.3, 0≦y≦0.5, 0≦z≦0.5. Typically, cathodes especially well suited for use in the present methods include Li₁₊ₐMn_{2-b}Mc_{b}O_{4-c}A_{c}, wherein Mc is a divalent transition metal, 0.0≦a≦0.5, 0.0≦b≦0.5, 0.0≦c≦0.2, and A is sulfur or fluorine. Suitable anodes for use the present invention comprise a material selected from graphite, amorphous carbon, Li₄Ti₅O₁₂, tin alloys, silica alloys, intermetallic compounds, lithium metal, and mixtures of two or more thereof. Suitable graphitic materials include natural graphite, artificial graphite, graphitized meso-carbon microbeads, and graphite fibers, as well as any amorphous carbon materials.

The fabrication of lithium rechargeable cells further includes the following steps. A non-activated cell is made by stacking, folding, winding or otherwise arranging the electrodes without an electrolyte solution. At least one of the electrodes has the gellable microporous polymer layer on its surface. The electrolyte solution comprising a lithium salt is injected in the cell to activate the gel process. The cell is stored in an oven at a temperature below 80° C. for at least 30 seconds to convert the gellable microporous polymer layer to a homogeneous gel polymer electrolyte. Typically the heating step is carried out at from about 30° to about 50° C. for at least five minutes.

The lithium salt to be used in the present invention is not particularly limited, as long as it serves as an electrolyte for a lithium secondary battery. Exemplary lithium salts include LiClO₄, LiBF₄, LiAsF₆, LiPF₆, LiCF₃SO₃, Li(CF₃SO₂)₂N, Li(CF₃SO₂)₃C, LiN(SO₂C₂F₅) ₂), lithium alkyl fluorophosphates, lithium (chelato)borates such as Li[(C₂O₆)₂B] (lithium bis(oxalato)borate, also known as LiBOB) and Li(C₂O₄)BF₂, and combinations of any two or more thereof. The molar concentration of the electrolyte is typically from about 0.2 to about 2.0. Electrolyte solvents contemplated for use in the present invention include ethylene carbonate (EC), diethyl carbonate (DEC), propylene carbonate (PC), dimethyl carbonate (DMC), methylethyl carbonate (MEC), γ-butyrolactone (GBL), methyl propionate (MP), butyl propionate (BP), ethyl propionate (EP), sulfolane, 1,2-dimethoxyethane (DME), 1,2-diethoxyethane (DEE), tetrahydrofuran (THF), 1,3-dioxolane, and 4-methyl-1,3-dioxolane. The cell electrolyte solvent can be a blend of two or more such solvents.

It has unexpectedly been discovered that the thermally bonded gellable microporous polymer layer of the invention greatly improves the high temperature cycling of spinel (such as LiMn₂O₄) based lithium rechargeable cells. In general, the high temperature cycling performance of lithium rechargeable cells using a spinel cathode and a graphite anode is very poor. This is believed to be due to the migration of dissolved Mn(II) from spinel which contaminates the surface of the graphite anode. To suppress the degradation of graphite anodes by dissolved Mn(II) for lithium rechargeable cells, several methods have been reported such as an addition of Lithium Nickelate compounds to the spinel (Z. Ma et al., Electrochemistry Communications, vol. 3, pp. 425-428, 2001, and T. Numata et al., Journal of Power Sources, vol. 97-98, pp. 358-360, 2001), addition of inorganic electrolyte additives such as LiI (S. Komaba et al, Journal of Power Sources, vol. 119-121, pp. 378-382, 2003), and the use of non-acid-generating lithium salts such as LiBOB (K. Amine et al., Journal of Power Sources, Vol. 129, pp. 14-19, 2004). None of these approaches provide a complete solution for the problem. However, as shown in the Examples, use of these methods in combination with the present invention, significantly enhances high temperature cycling of spinel cathodes.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

The present invention, thus generally described, will be understood more readily by reference to the following examples, which are provided by way of illustration and are not intended to be limiting of the present invention.

### EXAMPLES

### Example 1

The method to make an electrode with a gelled polymer layer is shown in FIG. 1. A plasticized poly(vinylidene fluoride-co-hexafluoropropylene) (PVdF-HFP, purchased from Atochem, Kynar2801 grade) film was prepared from a polymer solution made up of 30 weight percent (wt %) of PVdF-HFP, 50 wt % of dibutylphthalate (DBP, purchased from Aldrich Chem. Co.), 20 wt % of surface silanized fumed silica (Cabot, TS-530 grade), and acetone (Aldrich Chem. Co.) as a solvent by casting it onto glass plate and drying. The plasticized PVdF-HFP film was directly laminated onto the surface of cathode and/or anode by passing the two components through a heated roller at about 120° C. Through thermal fusion, the PVdF film slightly melted and penetrated into the surface of the electrode to form a tightly laminated polymer layer. The composition of the cathode is 84 wt % LiNi_{0.8}Co_{0.15}Al_{0.05}O₂, 8 wt % PVdF binder, 4 wt % SFG-6 graphite and 4 wt % carbon black. The composition of the anode is 92 wt % of MCMB2528 (Osaka Gas) and 8 wt % PVdF binder. The electrode with the polymer layer was dipped into diethyl ether (Aldrich Chem. Co.) to extract the plasticizer and dried to form the microporous structure. The cross-sectional view of the MCMB anode with microporous PVdF-HFP layer is shown in FIG. 2. The polymer layer can be converted to the gel polymer electrolyte after absorbing an electrolyte solution such as 1.2M LiPF₆ in EC/PC/DMC (1/1/3 by wt.).

### Example 2

Table 1 shows the rated capability of a lithium rechargeable cell made up of LiNi_{0.8}CO_{0.15}Al_{0.05}O₂ cathode//1.2 M LiPF₆ in EC/PC/DMC (1/1/3 by wt.)//MCMB2528 anode with the microporous PVdF-HFP layer (the thickness of the polymer layer is ca. 30 μm). The composition of the cathode is 84 wt % LiNi_{0.8}Co_{0.15}Al_{0.05}O₂, 8 wt % PVDF binder, 4 wt % SFG-6 graphite and 4 wt % carbon black. The composition of the anode is 92 wt % of MCMB2528 and 8 wt % PVdF binder. The effective cell area was 1.6 cm². The charge rate was C₁/2 mA and the discharge rates were C₁/5 mA, C₁/1 mA (2 mA), 2 CmA, 3 CmA and 5 CmA. As shown in Table 1, even at the 5C rate, the cell generates very good discharge capacity of above 140 mAh/g (1.760 mAh).

TABLE 1

| | Current Density | Discharge Capacity | Capacity Retention |
|---|---|---|---|
| C-Rate | (mA/cm²) | (mAh) | (%) |
| 0.5 | 0.63 | 1.955 | 100.0 |
| 1.0 | 1.25 | 1.897 | 97.0 |
| 2.0 | 2.50 | 1.903 | 97.3 |
| 3.0 | 3.75 | 1.864 | 95.3 |
| 5.0 | 6.25 | 1.765 | 90.3 |

### Example 3

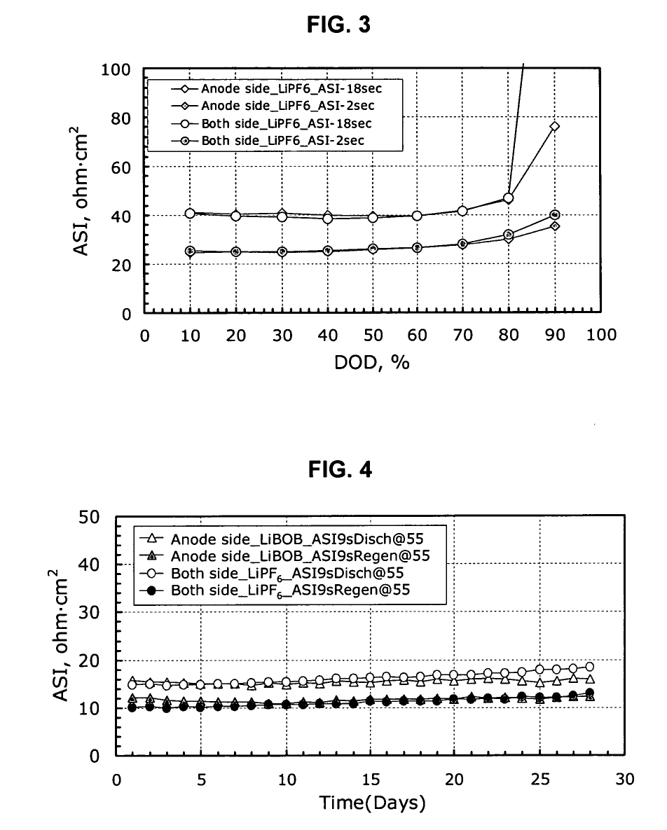

FIG. 3 shows the hybrid pulse power characteristics (HPPC) test of lithium rechargeable cells. One cell is made up of LiNi_{0.8}Co_{0.15}Al_{0.05}O₂ cathode//1.2 M LiPF₆ in EC/PC/DMC (1/1/3 by wt.)//MCMB2528 anode with the microporous PVdF-HFP layer (the thickness of the polymer layer is ca. 30 μm). The other is made up of LiNi_{0.8}Co_{0.15}Al_{0.05}O₂ cathode with the microporous PVdF-HFP layer (the thickness of the polymer layer is ca. 30 μm)//1.2 M LiPF₆ in EC/PC/DMC (1/1/3 by wt.)//MCMB2528 anode with the microporous PVdF-HFP layer (the thickness of the polymer layer is ca. 30 μm). The composition of the cathode is 84 wt % LiNi_{0.8}Co_{0.05}Al_{0.05}O₂, 8 wt % PVDF binder, 4 wt % SFG-6 graphite and 4 wt % carbon black. The composition of the anode is 92 wt % of MCMB2528 (Osaka Gas) and 8 wt % PVdF binder. The effective cell area was 1.6 cm². A 5 CmA pulse current was applied at each 10% DOD to investigate their area specific impedances (ASI). As shown in FIG. 3, both cells show similar ASI values that are very close to that needed for HEV application.

### Example 4

FIG. 4 shows the calendar life test at 550C of lithium rechargeable cells. One cell is made up of LiNi_{0.8}Co_{0.15}Al_{0.05}O₂ cathode//0.7 M LiBOB in EC/PC/DMC (1/1/3 by wt.)//MCMB2528 anode with the microporous PVdF-HFP layer (the thickness of the polymer layer is ca. 30 μm). The other is made up of LiNi_{0.8}Co_{0.15}Al_{0.05}O₂ cathode with the microporous PVdF-HFP layer (the thickness of the polymer layer is ca. 30 μm)//1.2 M LiPF₆ in EC/PC/DMC (1/1/3 by wt.)//MCMB2528 anode with the microporous PVdF-HFP layer (the thickness of the polymer layer is ca. 30 μm). The composition of the cathode is 84 wt % LiNi_{0.8}Co_{0.15}Al_{0.05}O₂, 8 wt % PVDF binder, 4 wt % SFG-6 graphite and 4 wt % carbon black. The composition of the anode is 92 wt % of MCMB2528 and 8 wt % PVdF binder. The effective cell area was 1.6 cm². Both cells were charged up to 60% state of charge SOC (3.723V) and kept at 55° C. oven. One 3 CmA pulse current was applied at each day to investigate ASI change during calendar life test. As shown in FIG. 4, both cells show very low ASI values that meet the requirements of HEV applications.

### Example 5

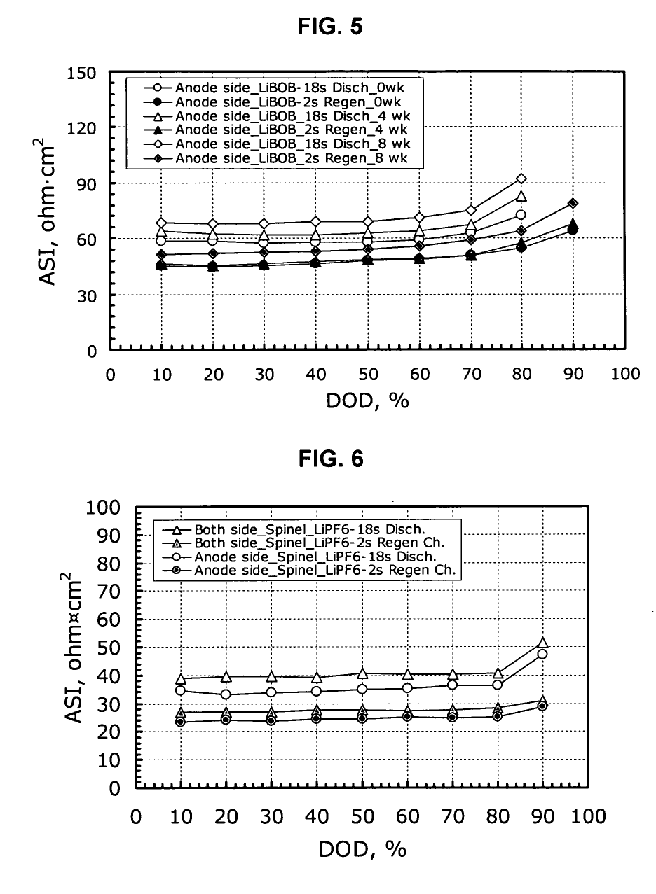

FIG. 5 shows the ASI changes in HPPC tests of a lithium rechargeable cell after 0, 4, and 8 weeks of aging at 55° C. The cell is made up of LiNi_{0.8}Co_{0.15}Al_{0.05}O₂ cathode//0.7M LiBOB in EC/PC/DMC (1/1/3 by wt.)//MCMB2528 anode with the microporous PVdF-HFP layer (the thickness of the polymer layer is ca. 30 μm). The composition of the cathode is 84 wt % LiNi_{0.8}CO_{0.15}Al_{0.05}O₂, 8 wt % PVDF binder, 4 wt % SFG-6 graphite and 4 wt % carbon black. The composition of the anode is 92 wt % of MCMB2528 (Osaka Gas) and 8 wt % PVdF binder. The effective cell area was 1.6 cm². A 5 CmA pulse current was applied at each 10% DOD to investigate their area specific impedances (ASI). The ASI was measured at 25° C. after cooling down the cell taken out of a 55° C. heat chamber. As shown in FIG. 5, the ASI of the cell is not much increased after 8 weeks of aging at 55° C.

### Example 6

Table 2 shows the rated capability of a lithium rechargeable cell made up of Li_{1.156}Mn_{1.844}O₄ cathode//1.2 M LiPF₆ in EC/PC/DMC (1/1/3 by wt.)//MCNM2528 anode with the microporous PVdF-HFP layer (the thickness of the polymer layer is ca. 30 μm). The composition of the cathode is 84 wt % LiNi_{0.8}Co_{0.15}Al_{0.05}O₂, 8 wt % PVDF binder, 4 wt % SFG-6 graphite and 4 wt % carbon black. The composition of the cathode is 80 wt % Li_{1.156}Mn_{1.844}O₄, 10 wt % PVDF binder, 5 wt % SFG-6 graphite and 5 wt % carbon black. The effective cell area was 1.6 cm². The charge rate was C/2 and the discharge rates were C₁/2 mA, C₁/1 mA (1.85 mA), 2 CmA, 3 CmA and 5 CmA, and 10 CmA. As shown in Table 2, even at 10 CmA rate, the capacity retention compared to C₁/2 mA capacity was above 83%.

TABLE 2

| C-Rate | Current Density | Discharge Capacity | Capacity Retention |
|---|---|---|---|
| (CmA) | (mA/cm²) | (mAh) | (%) |
| 0.2 | 0.23 | 1.753 | 100.0 |
| 1.0 | 1.15 | 1.712 | 97.7 |
| 2.0 | 2.30 | 1.705 | 97.3 |
| 3.0 | 3.45 | 1.706 | 97.3 |
| 5.0 | 5.75 | 1.684 | 96.1 |
| 10.0 | 11.50 | 1.463 | 83.5 |

### Example 7

FIG. 6 shows the results of HIPPC tests of lithium rechargeable cells. One cell is made up of Li_{1.156}Mn_{1.844}O₄ cathode//1.2 M LiPF₆ in EC/PC/DMC (1/1/3 by wt.)//MCMB2528 anode with the microporous PVdF-HFP layer (the thickness of the polymer layer is ca. 30 μm). The other is made up of Li_{1.156}Mn_{1.844}O₄ cathode with the microporous PVdF-HFP layer (the thickness of the polymer layer is ca. 30 μm)/1.2 M LiPF₆ in ECIPC/DMC (1/1/3 by wt.)//MCMB 2528 anode with the microporous PVdF-HFP layer (the thickness of the polymer layer is ca. 30 μm). The composition of the cathode is 80 wt % Li_{1.156}Mn_{1.844}O₄, 10 wt % PVDF binder, 5 wt % SFG-6 graphite and 5 wt % carbon black. The composition of the anode is 92 wt % of MCMB2528 and 8 wt % PVdF binder. The effective cell area was 1.6 cm². SCmA pulse current was applied at each 10% DOD to investigate their area specific impedances (ASI). As shown in FIG. 6, both cells show good ASI values, and especially the cell with the microporous PVdF-HFP layer on the anode only shows excellent ASI values that meet the requirements of HEV applications.

### Example 8

### Comparative Example

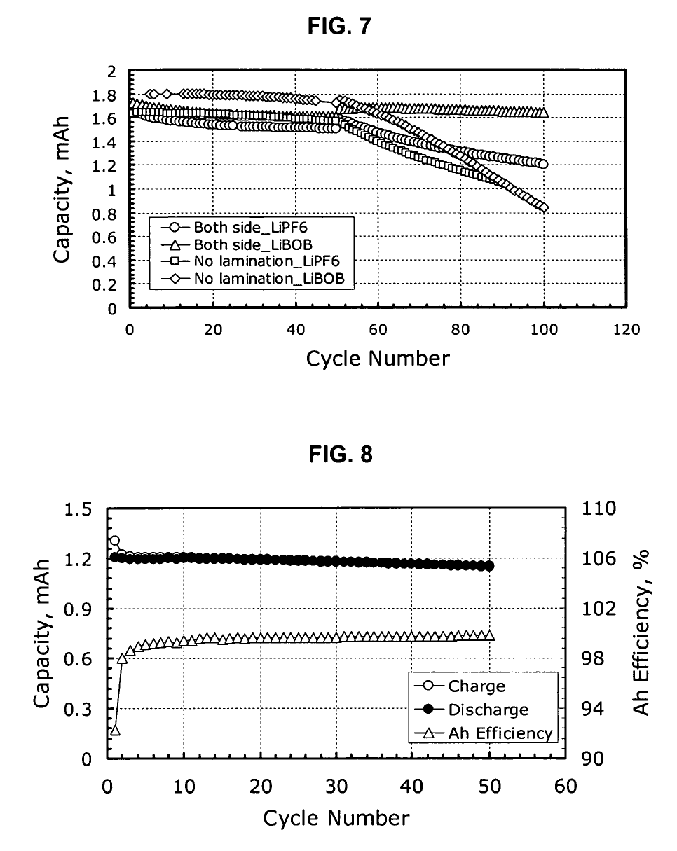

FIG. 7 shows the cycle life test of conventional lithium ion rechargeable type cells at C/2 rate (0.575 mA/cm²) as a function of cycle number. Test temperatures were 25° C. (up to 50 cycles) and 55° C. (from 51 to 100 cycles), respectively. One cell is made up of Li_{1.156}Mn_{1.844}O₄ cathode//1.2 M LiPF₆ in EC/PC/DMC (1/1/3 by wt.)//MCMB2528 anode. The other is made up of Li_{1.156}Mn_{1.844}O₄ cathode//0.7M LiBOB in EC/PC/DMC (1/1/3 by wt.)//MCMB2528 anode. The composition of the cathode is 80 wt % Li_{1.156}Mn_{1.844}O₄, 10 wt % PVDF binder, 5 wt % SFG-6 graphite and 5 wt % carbon black. The composition of the anode is 92 wt % of MCMB2528 (Osaka Gas) and 8 wt % PVdF binder. The effective cell area was 1.6 cm². As shown in FIG. 7, both cells show good cycle performance at 25° C., but the capacities quickly decayed at 55° C.

### Example 9

FIG. 7 shows the cycle life test of lithium rechargeable cells at C/2 rate (0.575 mA/cm²) as a function of cycle number. Test temperatures were 25° C. (up to 50 cycles) and 55° C. (from 51 to 100 cycles). One cell is made up of Li_{1.156}Mn_{1.844}O₄ cathode//1.2M LiPF₆ in EC/PC/DMC (1/1/3 by wt.)//MCMB2528 anode with the microporous PVdF-HFP layer (the thickness of the polymer layer is ca. 30 μm). The other is made up of Li_{1.156}Mn_{1.844}O₄ cathode with the microporous PVdF-HFP layer (the thickness of the polymer layer is ca. 30 μm)//0.7 M LiBOB in EC/PC/DMC (1/1/3 by wt.)//MCMB2528 anode with the microporous PVdF-HFP layer (the thickness of the polymer layer is ca. 30 μm). The composition of the cathode is 80 wt % Li_{1.156}Mn_{1.844}O₄, 10 wt % PVDF binder, 5 wt % SFG-6 graphite and 5 wt % carbon black. The composition of the anode is 92 wt % of MCMB2528 and 8 wt % PVdF binder. The effective cell area was 1.6 cm². As shown in FIG. 7, the microporous PVdF-HFP layers prevent or delay the capacity decay, and especially the cell shows a stabilized cycle performance at 55° C. by combining the microporous PVdF-HFP layer formation and LiBOB salt.

### Example 10

FIG. 8 shows the cycle life test of lithium rechargeable cell at C/2 rate (0.575 mA/cm²) as a function of cycle number at the temperatures of 55° C. The cell was made up of Li_{1.156}Mn_{1.844}O₄ cathode with the microporous PVdF-HFP layer (the thickness of the polymer layer is ca. 30 μm)H/0.7 M LiBOB in EC/PC/DMC (1/1/3 by wt.)H/GDR anode with the microporous PVdF-HFP layer (the thickness of the polymer layer is ca. 30 μm). The GDR is spherical natural graphite. The effective cell area was 1.6 cm². As shown in FIG. 8, the spinel//GDR based cell shows an excellent cycle performance at 55° C. by combining the microporous PVdF-HFP layer formation combined with LiBOB based electrolyte.

### Example 11

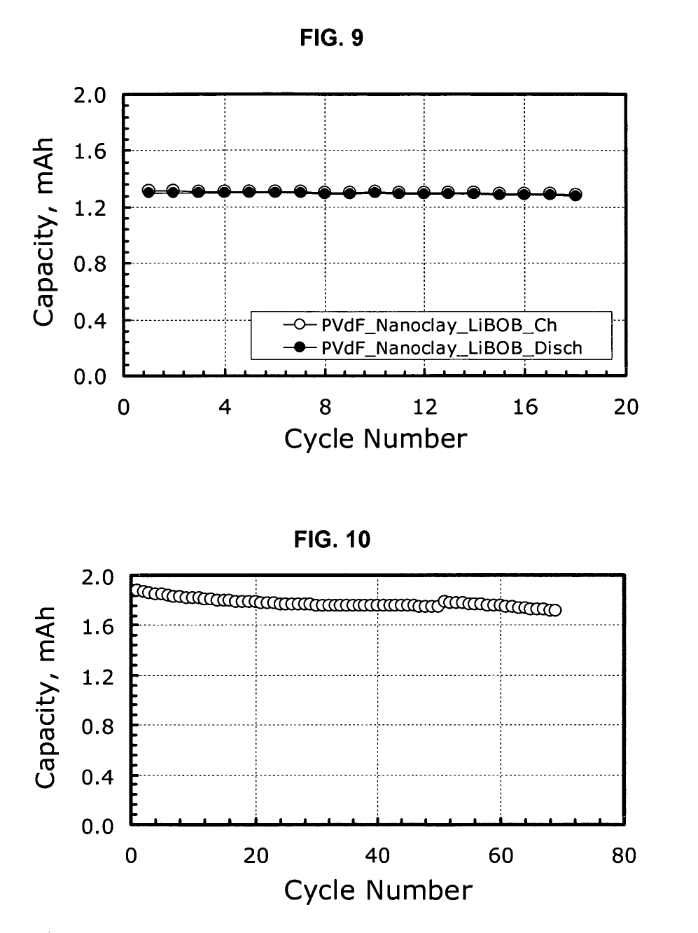

Hydrophobic-treated nanosized clay particles were used as an inorganic filler instead of the surface silanized fumed silica. The formulation for the fabrication of the gellable PVdF-HFP film and the processing for the formation of the layer on the electrode were same as in Example 1. A lithium rechargeable cell was fabricated with the composition of Li_{1.156}Mn_{1.844}O₄ cathode//0.7M LiBOB in EC/PC/DMC (1/1/3 by wt.)//MCMB2528 anode with the microporous PVdF-HFP layer with the hydrophobic treated nanoclay (the thickness of the polymer layer is ca. 28 μm). The cycle life test of the cell at C/2 rate (0.575 mA/cm²) as a function of cycle number was done at the temperatures of 55° C. As shown in FIG. 9, the cell shows very stable cycle performance at 55° C. by combining the microporous gellable PVdF-HFP layer with the nanoclay.

### Example 12

FIG. 10 shows the cycle life test of lithium rechargeable cell at C/2 rate (0.575 mA/cm²) as a function of cycle number. Test temperatures were 25° C. (up to 50 cycles) and 55° C. (from 51 to 70 cycles). The cell was made up of a blend cathode//1.2M LiPF₆ in EC/PC/DMC (1/1/3 by wt.)//MCMB2528 anode with the microporous PVdF-HFP layer (the thickness of the polymer layer is ca. 30 μm). The composition of the blend cathode is 64 wt % Li_{1.156}Mn_{1.844}O₄, 16 wt % LiNi_{0.8}Co_{0.15}Al_{0.05}O₂, 10 wt % PVDF binder, 5 wt % SFG-6 graphite and 5 wt % carbon black. The composition of the anode is 92 wt % of MCMB2528 and 8 wt % PVdF binder. The effective cell area was 1.6 cm². As shown in FIG. 10, the cell shows a stabilized cycle performance at 55° C. by combining the microporous PVdF-HFP layer formation and the addition of LiNi_{0.8}Co_{0.15}Al_{0.05}O₂ in the cathode.

### Example 13

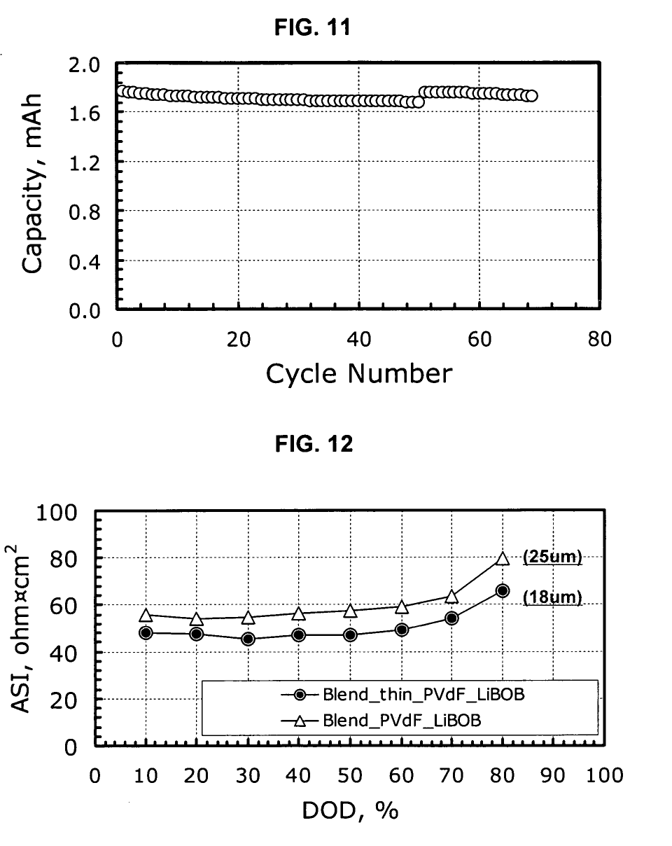

FIG. 11 shows the cycle life test of lithium rechargeable cell at C/2 rate (0.575 mA/cm²) as a function of cycle number. Test temperatures were 25° C. (up to 50 cycles) and 55° C. (from 51 to 70 cycles). The cell was made up of a blend cathode//0.7M LiBOB in EC/PC/DMC (1/1/3 by wt.)//MCMB2528 anode with the microporous PVdF-HFP layer (the thickness of the polymer layer is ca. 30 μm). The composition of the blend cathode is 64 wt % Li_{1.156}Mn_{1.844}O₄, 16 wt % LiNi_{0.8}Co_{0.15}Al_{1.05}O₂, 10 wt % PVDF binder, 5 wt % SFG-6 graphite and 5 wt % carbon black. The composition of the anode is 92 wt % of MCMB2528 and 8 wt % PVdF binder. The effective cell area was 1.6 cm². As shown in FIG. 11, the cell shows a stabilized cycle performance at 55° C. by combining the microporous PVdF-HFP layer formation, the addition of LiNi_{0.8}Co_{0.15}Al_{0.05}O₂ in the cathode, and LiBOB salt.

### Example 14

FIG. 12 shows the results of the HPPC test of lithium rechargeable cells vary according to the thickness of the PVdF-HFP layer on the surface of the electrodes. Thinner PVdF-HFP film was fabricated using the composition of 5.0 wt % of PVdF-HFP, 8.3 wt % of dibutylphthalate (DBP, purchased from Aldrich Chem. Co.), 3.3 wt % of surface silanized fumed silica (Cabot, TS-530 grade), and 83.4 wt % of acetone (Aldrich Chem. Co.) as a solvent by casting it onto glass plate with 200 μm of casting thickness. After drying at room temperature, ca. 25 μm of thinner PVdF-HFP was acquired. The thinner plasticized PVdF-HFP film was directly laminated onto the surface of MCMB2528 anode by passing the two components through a heated roller at about 120° C. The cells were made up of a blend cathode//0.7M LiBOB in EC/PC/DMC (1/1/3 by wt.)//MCMB2528 anode with the gellable microporous PVdF-HFP layer having two different thickness of the polymer layer (ca. 30 μm and ca. 18 μm). The composition of the blend cathode is 64 wt % Li_{1.156}Mn_{1.844}O₄, 16 wt % LiNi_{0.8}Co_{0.15}Al_{0.05}O₂, 10 wt % PVDF binder, 5 wt % SFG-6 graphite and 5 wt % carbon black. The composition of the anode is 92 wt % of MCMB2528 and 8 wt % PVdF binder. The effective cell area was 1.6 cm². As shown in FIG. 12, a reduction of the ASI is observed by reducing the thickness of the gellable PVdF-HFP layer.

While certain embodiments have been illustrated and described, it should be understood that changes and modifications can be made therein in accordance with one of ordinary skill in the art without departing from the invention in its broader aspects. Various features of the invention are defined in the following claims.

1. A method of fabricating a battery comprising laminating a gellable polymer film to at least one electrode and forming a microporous gellable polymer layer from the laminated film on the electrode.

2. The method of claim 1 wherein the gellable polymer film is thermally laminated to the electrode.

3. The method of claim 2 wherein the lamination temperature is from about 50° C. to about 130° C.

4. The method of claim 1 wherein the gellable polymer film comprises a gellable polymer, an inorganic filler, and a plasticizer.

5. The method of claim 4 wherein forming the microporous gellable polymer layer comprises extracting the plasticizer from the laminated film with a solvent.

6. The method of claim 5 wherein the plasticizer is extracted by dipping the laminated polymer film into the solvent one or more times and removing the solvent.

7. The method of claim 5 wherein the solvent is a carbonate, ether, alcohol, ester, or a mixture of any two or more thereof.

8. The method of claim 4 wherein the plasticizer is an alkylphthalate.

9. The method of claim 4 wherein the plasticizer is dibutylphthalate, dioctylphthalate, polyethylene glycol, or mixtures of any two or more thereof.

10. The method of claim 4 wherein the inorganic filler is fumed silica, alumina, clay, molecular sieve, metallic stearates, hydrotalcite, hydrocalumite, zinc oxide, zirconium oxide, tungsten oxide, titanium oxide, or mixtures of any two or more thereof.

11. The method of claim 4 wherein the gellable polymer comprises poly(vinylidene fluoride), poly(vinylidene chloride), polyacrylonitrile, polyacrylate, polyethylene oxide, polyurethane, copolymers thereof, or mixtures of any two or more thereof.

12. The method of claim 1 further comprising forming the gellable polymer film on a porous nonwoven medium prior to lamination to the at least one electrode.

13. The method of claim 1 wherein the at least one electrode is a cathode or anode.

14. The method of claim 13, wherein the cathode comprises LiCoO₂, LiNiO₂, LiNi₁₋ₓCo_{y}Met_{z}O₂, LiMn_{0.5}Ni₀₅O₂, LiMn_{0.3}Co_{0.3}Ni_{0.3}O₂, LiFePO₄, LiMn₂O₄, LiFeO₂, vanadium oxide, and mixtures of any two or more thereof, wherein Met is Al, Mg, Ti, B, Ga, or Si; and 0.0≦x≦0.3, 0.0≦y≦0.5, 0.0≦2≦0.5.

15. The method of claim 13, wherein the cathode comprises Li₁₊ₐMn_{2-b}Mc_{b}O_{4-c}A_{c}, wherein Mc is a divalent transition metal, 0.0≦a≦0.5, 0.0≦b≦0.5, 0.0≦c≦0.2, and A is sulfur or fluorine.

16. The method of claim 13, wherein the anode comprises graphite, carbon, Li₄Ti₅O₁₂, tin alloys, silica alloys, intermetallic compounds, lithium metal, and mixtures of any two or more thereof.

17. The method of claim 1 further comprising exposing the one or more electrodes to an electrolyte solution comprising a lithium salt, thereby forming a gel layer from the microporous gellable polymer layer.

18. The method of claim 17 wherein the lithium salt is LiClO₄, LiBF₄, LiAsF₆, LiPF₆, LiCF₃SO₃, Li(CF₃SO₂)₂N, Li(CF₃SO₂)₃C, LiN(SO₂C₂F₅)₂, lithium alkyl fluorophosphate, lithium (chelato)borate, or mixtures of two or more thereof.

19. The method of claim 17 wherein the lithium salt is lithium Li[(C₂O₄)₂B], Li(C₂O₄)BF₂, or a mixture thereof.

20. The method of claim 1 further comprising preparing the gellable polymer film from at least polymerizable monomers, inorganic filler, and plasticizer.

21. The battery formed by the method of claim 1.
